(19) United States
(12) Patent Application Publication
(10) Pub. No.: US 2005/0253680 A1
(43) Pub. Date: Nov. 17, 2005

(54) Temperature-controlled actuator

(76) Inventors: Eric D. Mathews, Needham, MA (US); Paul J. Dobson, Hanover, MA (US)

Correspondence Address: FISH & RICHARDSON PC, P.O. BOX 1022, MINNEAPOLIS, MN, 55440-1022, US

(21) Appl. No.: 10/509,713

(22) PCT Filed: Apr. 2, 2003
(86) PCT No.: PCT/US03/10140

§ 371 Date: May 6, 2005

Related U.S. Application Data
(60) Provisional application No. 60/369,886, filed on Apr. 4, 2002.

(51) Int. Cl. H01H 37/52; H01H 37/50

(52) U.S. Cl. 337/395; 337/333

(57) ABSTRACT

A temperature-controlled actuator has a housing (12) with a proximal end and a moveable distal portion. A core-wire (16) extends along the housing, with its distal section anchored to the distal portion of the housing. The core-wire's distal section has an austenite state and a martensite state. The distal section moves the distal portion by transitioning between the austenite and martensite states in response to a temperature change along a thermometric section (22, 24) of the core-wire. A proximal section in mechanical communication with the core-wire's distal section transmits tension, provided by a tensioning element (20), to the distal section. The tensioning element, which is coupled to the proximal section of the core-wire, constantly applies a tensioning force to the core-wire.

### FIELD OF INVENTION

This invention relates to control systems, and in particular, to temperature-controlled actuators.

### BACKGROUND

In automatic control systems, a temperature sensitive controller is useful for controlling a system based on a change in temperature. . In many controllers, a change in temperature causes a change in some electrical quantity. Examples of such devices include thermistors and resistance temperature detectors (“RTDs”), in which a resistance varies with temperature, and thermocouples, in which a resistance generates a voltage. In such devices, the temperature sensor is placed within the region whose temperatures is to be measured. The sensor generates a signal that can then be transmitted to a switch located outside that region.

Controllers of the foregoing type have two discrete elements: a temperature measurement device to generate a temperature-dependent signal, and a separate electromechanical or electronic actuator for receiving that signal and performing some action on the basis of that signal. As long as an electrical link is provided, the temperature sensor can be separated from the actuator. This is particularly useful when the temperature sensor is to be exposed to a harsh environment.

Another temperature sensitive controller uses a bimetallic strip as a temperatures sensing element. Such controllers are purely mechanical. No electrical signal is needed to drive the actuator because, in effect, the bimetallic strip is both the temperature sensor and the actuator. As the bimetallic strip experiences temperature change, it moves, almost imperceptibly. This temperature-induced motion can be used to, for example, operate a switch.

The bimetallic strip is simple to make and requires no power. In addition, the set point of a control system can easily be adjusted by appropriately biasing the strips. However, a bimetallic strip is unsuited for harsh environments because it is difficult to separate the temperature sensor from the actuator. In addition, it is difficult to accurately control a set point with a bimetallic strip.

Another type of thermally controlled actuator relies on a temperature-dependent phase change or chemical reaction. An example of such an actuator is a spring-loaded element that is held in place by a metal having a melting point lower than that of the spring. When the temperature exceeds the melting point, the metal liquefies, thus releasing the spring-loaded element. Actuators of this type, however, cannot easily be re-used.

### SUMMARY

The invention is based, in part, on the recognition that a temperature-dependent transition between martensite and austenite states of an alloy can be harnessed to permit a temperature change to trigger mechanical motion.

In one aspect, the invention includes a temperature-controlled actuator having a housing with a proximal end and a moveable distal portion. A core-wire extends along the housing, with its distal section anchored to the distal portion of the housing. The core-wire's distal section has an austenite state and a martensite state. The distal section is configured to move the distal portion of the housing by transitioning between the austenite state and the martensite state in response to a temperature change along a thermometric section of the core-wire. A proximal section in mechanical communication with the core-wire's distal section transmits tension, provided by a tensioning element, to the distal section. The tensioning element, which is coupled to the proximal section of the core-wire, is configured to constantly apply a tensioning force to the core-wire.

In one embodiment, the temperature controlled actuator has a distal section that includes a nickel-titanium alloy. Other embodiments include those in which the housing includes a flexible tube, a tube having a flexible distal portion, or a tube having a hinged distal portion. The housing can be configured to define a path when in a compressed state. The flexible distal portion can be configured to assume a pre-determined shape when relaxed. A proximal portion of the tube can be enclosed by a rigid sleeve.

In another embodiment, the austenite transition temperature of the distal section exceeds an austenite transition temperature of the proximal section. The thermometric section of the core-wire can be the distal section of the core-wire, the proximal section of the core-wire, or an intermediate section of the core-wire.

One embodiment of the actuator includes an intermediate section between the proximal section and the distal section. The intermediate section includes can be an alloy having an austenite state and a martensite state. In this case, the proximal section can be an extension of the intermediate section. This extension has a smaller diameter than the diameter of the intermediate section.

In some embodiments, the proximal section is in an austenite state when the distal section is in a temperature-induced martensite state. In these embodiments, the diameter of the proximal section is selected such that the tensioning force causes the proximal section to be in a stress-induced martensite state when the distal section is in a temperature-induced austenite state.

Conversely, other embodiments include those in which the proximal section is in a temperature-induced martensite state when the distal section is in an austenite state. In these embodiments, the diameter of the distal section is selected such that the tensioning force causes the distal section to be in a stress-induced martensite state when the proximal section is in a temperature-induced austenite state.

The tensioning element can apply a constant force or a variable force. Examples of tensioning elements include a mass suspended from the core-wire, an axially moveable member engaging the core-wire, the axial position of which controls the tension in the core-wire, a spring loaded plate pushing against the core wire, or a screw applying tension to the core wire.

Another aspect of the invention is a method for providing a mechanical response to a temperature change in a monitored environment. The method includes anchoring a distal section of a core-wire to a distal portion of a housing. The distal section has an austenite state and a martensite state. The core-wire is then biased with a tensile force. A thermometric portion of the core-wire is then exposed to the monitored environment.

In one practice, exposing a thermometric portion of the core-wire includes exposing the distal section of the core-wire to the monitored environment. This practice of the invention can include causing a transition between an austenite state and a martensite state in the distal section in response to a temperature change along the distal section.

Alternatively, exposing a thermometric portion of the core-wire includes exposing the proximal section of the core-wire to the monitored environment. This alternative practice of the invention can include causing a transition between an austenite state and a martensite state in the proximal section in response to a temperature change along the proximal section. In response to this transition, the method optionally includes causing a transition between an austenite state and a martensite state in the distal section in response to the transition between an austenite state and a martensite state in the proximal section.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

Like reference symbols in the various drawings indicate like elements.

FIG. 1 is a schematic of an actuator in its relaxed state.

FIG. 2 is a schematic of the actuator of FIG. 1 in its tensioned state.

FIG. 3 is a cross-section of the actuator of FIG. 1 in its relaxed state.

FIG. 4 is a cross-section of the actuator of FIG. 1 in its tensioned state.

FIG. 5 is cross-sections of a second actuator in its relaxed state.

FIG. 6 is a cross-section of the actuator in FIG. 5 in its tensioned state.

FIG. 7 is a cross-section of a third actuator in its relaxed state.

FIG. 8 is a cross-section of the actuator in FIG. 5 in its tensioned state.

### DETAILED DESCRIPTION

Temperature-controlled actuators described herein use an inhomogeneous core-wire that, when subjected to a pulling force, stretches by different amounts at different locations. These different amounts depend, in part, on temperatures at various sections of the core-wire. At least one portion of the core-wire includes a shaped memory alloy that has been pre-heated to take a pre-defined shape when in its austenite state. This portion of the wire is attached to and controls the shape of a flexible portion of the actuator. A weight or other force applicator coupled to the proximal section of the core-wire maintains tension along the core-wire.

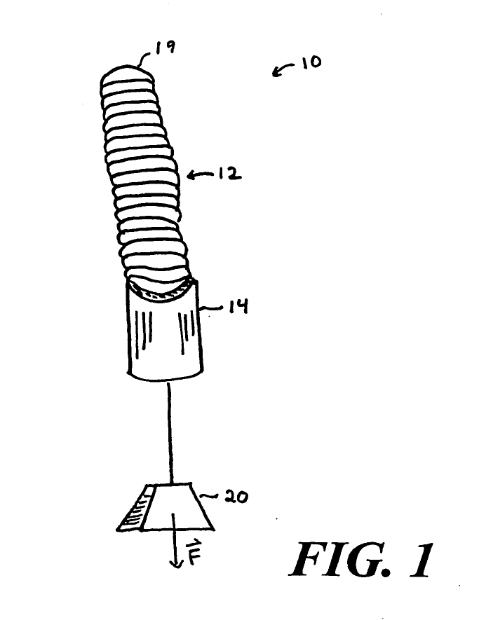

Referring to FIG. 1, a first embodiment of an actuator 10 incorporating the principles of the invention includes a housing 12 having a proximal portion and a distal portion. In the illustrated embodiment, the housing 12 is a flexible tube made of articulating segments. However, the housing 12 can also be a tube having a flexible distal portion and a rigid proximal portion. A housing 12 has an equilibrium compressed state in which it defines a pre-selected path. Additionally, the housing 12 can be a tube having a rigid distal portion coupled to a rigid proximal portion by one or more hinges to allow movement of the distal portion relative to the proximal portion. In other embodiments, the housing 12 need not be tubular at all, but can instead be open to its surroundings.

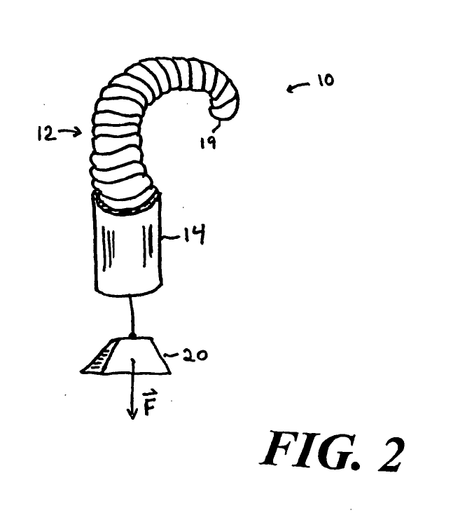

A sleeve 14 enclosing the proximal portion of the housing 12 provides rigid support to the proximal portion. The distal portion of the housing 12, however, is free to change its shape. In particular, the distal portion is free to change between a relaxed shape, shown in FIG. 1, and a tensioned shape, shown in FIG. 2. In FIGS. 1 and 2, the relaxed shape is a coil and the tensioned shape is straight. However, the invention is not constrained to these two particular configurations.

As indicated by FIG. 1, the housing 12 can be a segmented structure capable of articulation between its constituent segments. However, the housing 12 can also be any flexible section capable of freely making the required transition between the curved state of FIG. 2 and the extended state of FIG. 1. The housing 12 may be a close wound coil, with or without preload, or it may be an open wound coil. The housing 12 can include baffles, bellows, or any such flexible and compressible member.

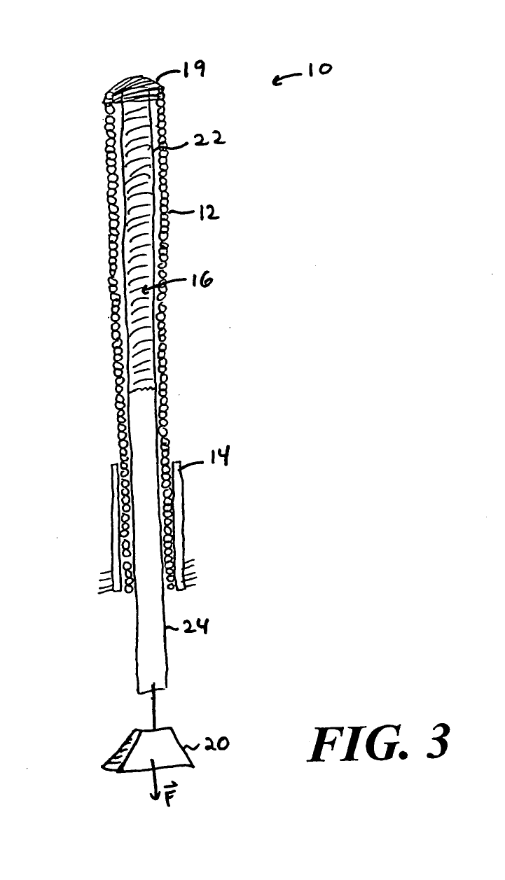

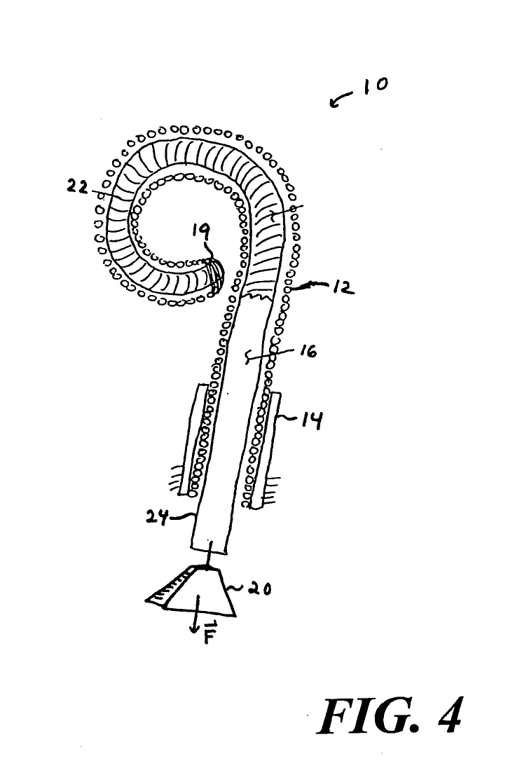

A cross-sectional view of the actuator 10, shown in FIGS. 3 and 4, reveals a portion of the structure that enables a change in temperature to toggle the housing 12 between its relaxed state and its tensioned state.

Referring to FIG. 3, a core-wire 16 anchored at an end cap 19 at the distal end of the housing 12 extends through a lumen between the distal and proximal ends thereof. The end cap 19 provides mechanical coupling between the core-wire 16 and the housing 12 so that a change in the path traced out by the core-wire 16 results in a corresponding change in the path traced out by the housing 12.

Coupling between the housing 12 and the core-wire 16 can also be provided by a direct connection between the housing 12 and the core-wire 16. In addition, the point of coupling need not be at the tip of the housing 12 as shown in FIG. 3. By proximally displacing the coupling point, for example, the tip can be made floppy.

A proximal end of the wire 16 is operably connected to a tensioning element 20 that applies a constant force, denoted by the force vector \vec{F}, to the proximal end of the core-wire 16. Because the core-wire 16 is anchored to the end cap 19, this constant force does not move the core-wire 16. Instead, it places the wire 16 under tension. This tension is manifested as a stress field throughout the core-wire 16. In response to the stress field, the core-wire 16 stretches. The design of the core-wire 16 is such that at a particular temperature, different portions of the core-wire 16 stretch by different amounts.

The tensioning element 20 is represented in FIG. 3 as a weight. However, any mechanism for applying a force can be used as a tensioning element 20. For example, a pulley may be used to direct the force at an angle relative to the force vector. The magnitude of the force need not be constant. In other embodiments, the weight can be replaced by a spring mechanism.

A distal section 22 of the core-wire 16 is made from a shaped-memory alloy. A suitable alloy from which the core-wire 16 can be manufactured is a nickel-titanium alloy sold under the trade name NITINOL™. Such an alloy has the property that when deformed and heated past a critical temperature, which is on the order of 700 degrees Fahrenheit for NITINOL, it “remembers” its deformed shape.

A distal section 22 is formed by deforming a distal section of the core-wire 16, heating it past a critical temperature, and then cooling it. The shape into which the distal section 22 is deformed then becomes the remembered shape. When treated in this manner, the distal section 22 acquires temperature-dependent mechanical properties. In particular, the distal section 22 has the property that it can be in one of two states: an austenite state, in which it reverts to its remembered shape, and a martensite state, in which it is super-elastic.

The state in which the distal section 22 of the core-wire 16 finds itself depends on its temperature. When heated past an austenite transformation temperature, the distal section 22 reverts to its austenite state. In this state, the distal section 22 has a tendency to recover its remembered shape. In addition, when the distal section 22 is stressed, it yields reluctantly. An applied stress on the distal section 22 in its austenite state results in comparatively little elongation of that section. In contrast, when cooled below a martensite transformation temperature, the distal section 22 becomes super-elastic. In its martensite state, the distal section 22 yields readily. Thus, an applied stress results in considerable strain, and hence considerable elongation of the distal section 22.

A proximal section 24 of the core-wire 16 is made of a rigid material, for example stainless steel, whose strain response is only weakly dependent on temperature. Alternatively, the proximal section 24 can be made of a super-elastic alloy having an austenite transformation temperature that is less than the austenite transformation temperature of the distal section 22.

In operation, the force applied by the tensioning element 20 urges the core-wire 16 to stretch. When the distal section 22 of the core-wire 16 is below its martensite transformation temperature, the distal section 22 loses its tendency to assume its remembered shape. In addition, the distal section 22 becomes super-elastic. As a result, most of this stretching occurs at the distal section 22. The proximal section 24, being more rigid than the super-elastic distal section 22, stretches very little. Because the distal end of the core-wire 16 is anchored to the end cap 19, there is a tendency for the core-wire 16 to straighten the distal section of the housing 12, as shown in FIG. 4.

In contrast, when the distal section 22 of the core-wire 16 is above its austenite transformation temperature, it loses its super-elastic properties and assumes its remembered shape. As a result, it stretches very little. In this case, what stretching occurs is borne by the proximal section 24. In addition, the distal section 22 reverts to its remembered shape. Because the core-wire 16 is mechanically coupled to the housing 12 by the end cap 19, the distal section of the housing 12 likewise assumes this remembered shape.

As noted above, a material such as NITINOL becomes super-elastic when it transitions from its austenite form to its martensite form. This can occur when the NITINOL, in its austenite form, is cooled to below its martensite transition temperature. Another way to cause a transition from austenite to martensite, however, is to pull so hard on an austenite wire that it turns into martensite. Martensite formed in this way is referred to as “stress-induced martensite”. Additional embodiments of the invention, described below, make use of stress-induced martensite.

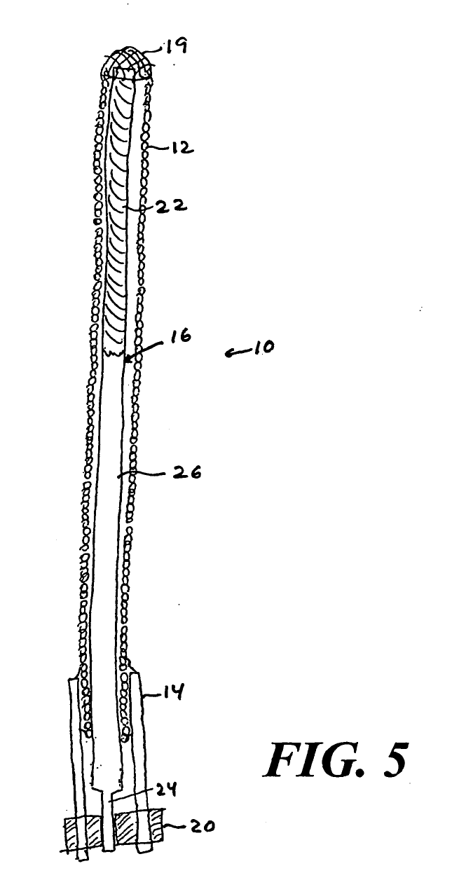

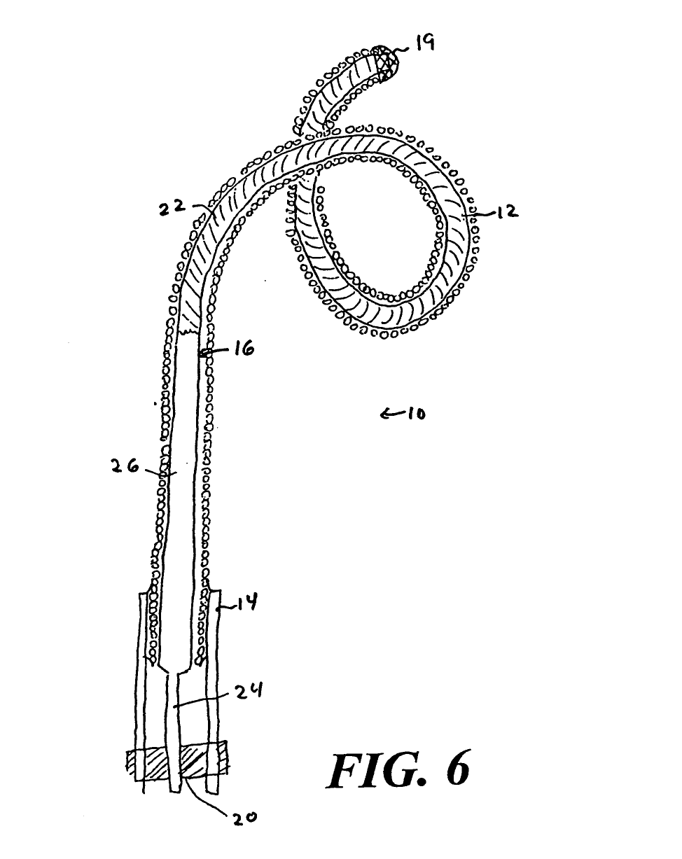

In a second embodiment, shown in FIGS. 5 and 6, the core-wire 16 has a distal section 22, a proximal section 24, and an intermediate section 26 between the distal and proximal sections 22, 24. The distal section 22 and the intermediate section 26 are similar to the distal section 22 and proximal section 24 described above in connection with the first embodiment.

As was the case with the first embodiment, a tensioning element 20 coupled to the proximal end applies a constant force that places the core-wire 16 in tension. The resulting tension causes a stress field throughout the core-wire 16, including within its proximal section 24. The strain experienced by the proximal section 24 in response to that stress depends in part on whether the distal section 22 is in its austenite state or in its martensite state.

Referring to FIG. 5, when the distal section 22 is below its martensite transition temperature, it becomes super-elastic. As a result, most of the stress imposed by the tensioning element 20 is relieved by the stretching of the distal section 22. Because the stress is relieved primarily by stretching of the distal section 22, the proximal section 24 undergoes comparatively little strain. As a result, the proximal section 24 remains in its austenite form.

Referring now to FIG. 6, when the distal section 22 is above its austenite transition temperature, it loses its super-elastic properties and reverts to its remembered shape. As a result, the distal section 22 no longer contributes so generously toward relieving the stress present throughout the core-wire 16. In this case, the stress strains the proximal section 24 and thereby causes it to transition into its martensite form. Once in its martensite form, the proximal section 24 becomes super-elastic. In its super-elastic form, the proximal section 24 stretches sufficiently to relieve the stress in the core-wire 16.

The proximal section 24 and the intermediate section 26 can be different materials. However, to avoid having to join the proximal and middle sections, it is convenient to make them integral with each other. In the illustrated second embodiment, the proximal section 24 is formed by grinding down a section of the core-wire 16. In this case, the proximal section 24 is that portion of the wire 16 whose diameter has been reduced by grinding and the intermediate section 26 is that portion of the wire 16 that retains its original diameter. Because the proximal section 24 has a smaller diameter than the intermediate section 26, it yields more to stress than does the intermediate section 26. This, in turn, ensures that the intermediate section 26 can remain in its austenite form even when the proximal section 24 has transitioned into its martensite form.

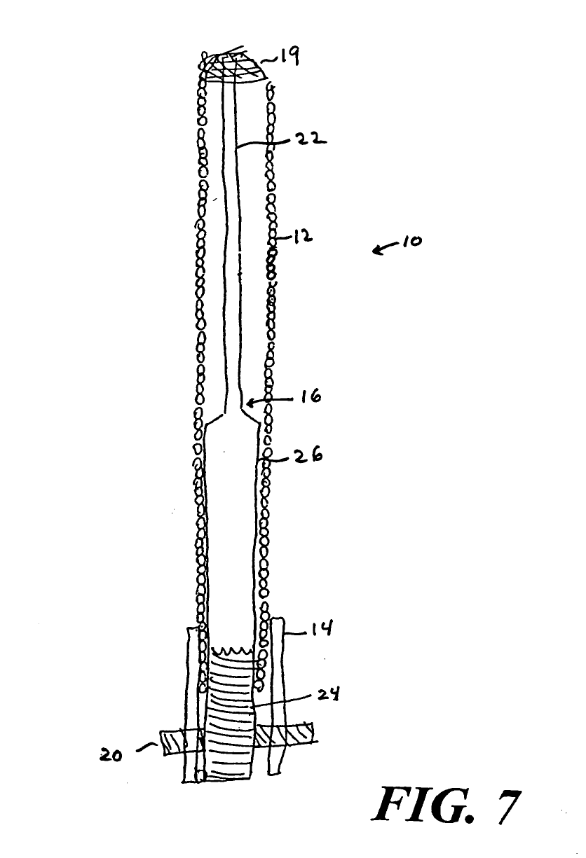

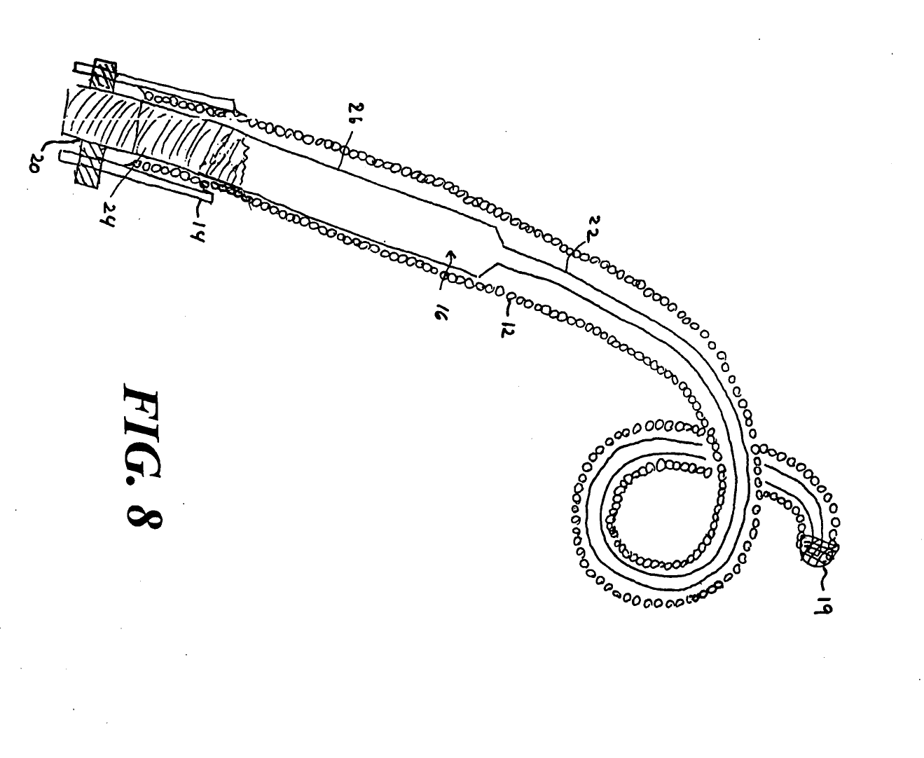

In a third embodiment, shown in FIGS. 7 and 8, the roles of the proximal and distal sections of the core-wire 16 are opposite those in the second embodiment. In this case, a NITINOL core-wire 16 has a reduced-diameter distal section 22. As a result, the distal end responds to sufficient stress by transitioning into stress induced martensite. In so doing, it acquires super-elastic properties and stretches as shown in FIG. 7. Because the core-wire 16 is coupled to the housing 12 by the end cap 19, this causes the housing 12 to straighten. In the absence of such stress, the distal end reverts to austenite and recovers a remembered shape. Again, because the core-wire 16 is coupled to the housing 12 by the end cap 19, this causes the housing 12 to assume that remembered shape.

The proximal section 24 of the core-wire 16 has an austenite transition temperature that is higher than the austenite transition temperature of the intermediate section 26 of the core-wire 16. As was the case with the second embodiment, a tensioning element 20 applies a pulling force to the proximal end.

Referring to FIG. 8, when the proximal end of the core-wire 16 is below its martensite transition temperature, it becomes martensite. As a result, it stretches considerably, so much so that it manages to relieve most of the stress applied throughout the core-wire 16. The proximal section 24 thus isolates the distal section 22 from stress sufficient to turn it into stress induced martensite. Because the distal section 22 remains austenite, it assumes its remembered shape. Because of the coupling between the core-wire 16 and the housing 12, the housing 12 likewise assumes the remembered shape.

Referring to FIG. 7, when the proximal section 24 is above its austenite transition temperature, it becomes austenite, and therefore does not stretch significantly in response to the applied stress. As a result, the stress must be borne by the remainder of the core-wire 16. Because of its reduced diameter, the distal section 22 of the core-wire 16 experiences considerable stress, enough to cause it to transition into stress-induced martensite. In doing so, it loses its remembered shape and straightens. Because of the coupling between the core-wire 16 and the housing 12, the housing 12 also straightens.

The tensioning element 20 shown in FIGS. 6-8 is a collar having a slot for accepting the sleeve 14 and a central opening for attachment to the core-wire 16. The slot enables the tensioning element 20 to move axially along the sleeve 14, thereby changing the tension applied to the core-wire 16. The axial position of the slot can be adjusted by, for example, by a rack and pinion arrangement. However, no particular form of tensioning element 20 is required. What is important is that the core-wire 16 be constantly sufficient tension to stretch a portion of the core-wire when the temperature provides an opportunity to do so.

Another embodiment of a tensioning element 20 is a screw that mounted across the diameter of the housing. The screw has a hole in its shaft that engages the core-wire 16. As the screw turns, the core-sire 16 can be tightened or loosened in the same manner that a string is tuned on a guitar or other stringed instrument.

The austenite transformation temperature and the martensite transformation temperature can be adjusted by known methods such as heat treating the alloy or doping the alloy.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A temperature-controlled actuator comprising:
a housing (12) having a proximal end and a moveable distal portion;
a core-wire (16) extending along the housing, the core-wire having
a distal section (22) anchored to the distal portion of the housing, the distal section having
an austenite state, and
a martensite state,
the distal section being configured to move the distal portion of the housing by transitioning between the austenite state and the martensite state in response to a temperature change along a thermometric section (22, 24) of the core-wire, and
a proximal section (24) in mechanical communication with the distal section, the proximal section transmitting tension to the distal section;
a tensioning element (20) coupled to the proximal section of the core-wire, the tensioning element being configured to constantly apply a tensioning force to the core-wire.

2. The temperature controlled actuator of claim 1, wherein the distal section comprises a nickel-titanium alloy.

3. The temperature controlled actuator of claim 1, wherein the housing comprises a flexible tube.

4. The temperature controlled actuator of claim 1, wherein the housing comprises a tube having a flexible distal portion.

5. The temperature controlled actuator of claim 4, wherein the flexible distal portion is configured to assume a pre-determined shape when in an equilibrium state.

6. The temperature controlled actuator of claim 1, wherein the housing comprises a tube having a hinged distal portion.

7. The temperature controlled actuator of claim 1, wherein the housing is configured to define a path when in a compressed state.

8. The temperature controlled actuator of claim 3, further comprising a rigid sleeve (14) enclosing a proximal portion of the flexible tube.

9. The temperature controlled actuator of claim 1, wherein an austenite transition temperature of the distal section exceeds an austenite transition temperature of the proximal section.

10. The temperature controlled actuator of claim 1, wherein the thermometric section comprises the distal section of the core-wire.

11. The temperature controlled actuator of claim 10, further comprising an intermediate section between the proximal section and the distal section.

12. The temperature controlled actuator of claim 11, wherein the intermediate section comprises an alloy having an austenite state and a martensite state, and the proximal section comprises an extension of the intermediate section, the extension having a smaller diameter than the intermediate section.

13. The temperature controlled actuator of claim 12,
wherein the proximal section is in an austenite state when the distal section in a temperature-induced martensite state, and
wherein the diameter of the proximal section is selected such that the tensioning force causes the proximal section to be in a stress-induced martensite state when the distal section is in a temperature-induced austenite state.

14. The temperature controlled actuator of claim 1, wherein the thermometric section comprises the proximal section of the core-wire.

15. The temperature controlled actuator of claim 11, wherein the proximal section is configured to transition between an austenite state and a martensite state in response to a temperature change along the proximal section of the core-wire.

16. The temperature controlled actuator of claim 12, wherein the distal section comprises an extension of the intermediate section, the extension having a smaller diameter than the intermediate section.

17. The temperature controlled actuator of claim 16,
wherein the proximal section is in a temperature-induced martensite state when the distal section is in an austenite state, and
wherein the diameter of the distal section is selected such that the tensioning force causes the distal section to be in a stress-induced martensite state when the proximal section is in a temperature-induced austenite state.

18. The temperature controlled actuator of claim 11, wherein an austenite transition temperature of the proximal section exceeds an austenite transition temperature of the intermediate section.

19. The temperature controlled actuator of claim 1, wherein the tensioning element is constantly biased to apply a constant force to the core-wire.

20. The temperature controlled actuator of claim 1, wherein the tensioning element is constantly biased to apply a variable force to the core-wire.

21. The temperature controlled actuator of claim 1, wherein the tensioning element comprises a mass suspended from the core-wire.

22. The temperature controlled actuator of claim 1, wherein the tensioning element comprises an axially moveable member engaging the core-wire, the axial position of the member controlling the tension in the core-wire.

23. A method for providing a mechanical response to a temperature change in a monitored environment, the method comprising:
anchoring a distal section of a core-wire to a distal portion of a housing, the distal section having an austenite state and a martensite state;
biasing the core-wire with a tensile force; and
exposing a thermometric portion of the core-wire to the monitored environment.

24. The method of claim 23, wherein exposing a thermometric portion of the core-wire comprises exposing the distal section of the core-wire to the monitored environment.

25. The method of claim 23, further comprising causing a transition between an austenite state and a martensite state in the distal section in response to a temperature change along the distal section.

26. The method of claim 23, wherein exposing a thermometric portion of the core-wire comprises exposing a proximal section of the core-wire to the monitored environment.

27. The method of claim 26, further comprising causing a transition between an austenite state and a martensite state in the proximal section in response to a temperature change along the proximal section.

28. The method of claim 26, further comprising causing a transition between an austenite state and a martensite state in the distal section in response to a transition between an austenite state and a martensite state in the proximal section.

29. The method of claim 23, wherein biasing the core-wire comprises applying a constant force to the core-wire.

30. The method of claim 23, wherein biasing the core-wire comprises applying a variable force to the core-wire.
